(19) United States
(12) Patent Application Publication
(10) Pub. No.: US 2008/0038654 A1
(43) Pub. Date: Feb. 14, 2008

(54) DOUBLE-COMPONENT DEVELOPER

(75) Inventors: Hiroshi YAMAZAKI, Tokyo (JP); Ken OHMURA, Tokyo (JP); Yoshiyasu MATSUMOTO, Tokyo (JP); Shiro HIRANO, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/779,765

(22) Filed: Jul. 18, 2007

(30) Foreign Application Priority Data
Aug. 8, 2006 (JP) 2006-215411

(51) Int. Cl. G03G 9/00

(52) U.S. Cl. 430/110.3

(57) ABSTRACT

An electrophotographic developer comprising a toner and a carrier is disclosed. The contains a toner binder resin, a colorant and a releasing agent, and a carrier contains magnetic particles dispersed in a carrier binder resin, wherein the releasing agent contains a first releasing agent component of a linear-chain hydrocarbon compound having a melting point of from 50 to 100° C. in a ratio of from 10 to 95% by weight and a second releasing agent component comprising a branched-chain structure hydrocarbon compound having a melting point of from 50 to 100° C. in a ratio of from 5 to 90% by weight, and the carrier has a shape coefficient SF-1 of from 1.0 to 1.2, a shape-coefficient SF-2 of from 1.1 to 2.5 and a volume based median diameter of from 10 to 100 μm.

This application is based on Japanese Patent Application No. 2006-215411 filed on Aug. 8, 2006, in Japanese Patent Office, the entire content of which is hereby incorporated by reference.

### TECHNICAL FIELD

The present invention relates to a double-component developer to be used for image formation by electrophotographic system.

### BACKGROUND

According to requirement of energy saving in electrophotographic system image forming apparatus, a low temperature fixation by which the fixation is carrying out at low temperature is developed for reducing energy consumption in the fixing device which consumes largest amount of energy in the image forming apparatus. For attaining the low temperature fixation, use of a releasing agent having low melting point is proposed; cf. for example, Patent Documents 1 and 2.

For example, a linear-chain hydrocarbon compound such as paraffin wax is useful as the releasing agent to be used for the low temperature fixation since which is a releasing agent having elative high hardness and low melting point.

However, the releasing agent having low melting point such as the linear-chain hydrocarbon compound causes a problem that the releasing agent itself is evaporated by heat for the fixing and a problem of that the developer is quickly degraded and the electrifying ability of the toner is lowered.

Patent Document 1: JP A 2000-321815

Patent Document 2: JP A 2000-275908

### SUMMARY OF THE INVENTION

The invention is attained on the above background. An object of the invention is to provide a double-component developer which is capable of being fixed with sufficient strength by the low temperature fixation and is high uniformly charged for long period so that high quality image can be formed for long period.

An aspect of the invention can be a double-component developer comprising a toner particle containing a binder resin, a colorant and a releasing agent, and a carrier comprising a binder resin and a magnetic fine particle dispersed in the binder resin. The releasing agent contains a first releasing agent component of a linear-chain hydrocarbon compound having a melting point of from 50 to 100° C. in a ratio of from 10 to 95% by weight and a second releasing agent component comprising a branched-chain structure compound having a melting point of from 50 to 100° C. in a ratio of from 5 to 90% by weight. The carrier has a shape coefficient SF-1 of from 1.0 to 1.2, a shape-coefficient SF-2 of from 1.1 to 2.5 and a volume based median diameter of from 10 to 100 μm.

The double-component developer of the invention can be fixed with sufficient fixation strength by the low temperature fixation though the melting point of the whole releasing agent is basically low because the releasing agent contained in the toner is composed of a specific mixture. Moreover, the developer comprises the resin dispersed type carrier having the specified shape, hereinafter also referred to as the specified resin dispersed type carrier, additionally to the specified releasing agent and the specified resin dispersed type carrier has high durability. Therefore, the carrier contamination is inhibited for long period and the toner is charged with high uniformity so that high quality images can be stably formed for prolonged period.

### BRIEF DESCRIPTION OF THE DRAWING

FIG. 1 shows a cross section of the fixing device to be installed in the image forming apparatus used in Examples 1 to 12 and Comparative examples 1 to 7.

### DETAIL DESCRIPTION OF THE EXEMPLARY EMBODIMENTS

As a result of investigation by the inventors on the reason of the above problems, it is found that a phenomenon so called carrier contamination is caused because the linear-chain hydrocarbon such as paraffin wax usually has relatively wide molecular weight distribution and the low molecular weight ingredient of the hydrocarbon compound having low melting point exposed at the toner surface is easily melted and transferred onto the carrier by slightly heating caused by slipping stress by friction between the carrier and the toner particle and transferred onto the carrier surface. As a result of the investigation for solving such the problem, it is found that the carrier contamination can be inhibited by mixing a straight chain hydrocarbon compound releasing agent with a hydrocarbon compound releasing agent comprising hydrocarbon compound having branched structure, hereinafter referred also to as a branched-hydrocarbon type wax. Thus the invention can be attained.

Though the reasons of the inhibition of carrier contamination is not cleared, one of which is supposed that the branched-hydrocarbon type wax tends to be entangled with the molecules since it has the branched or cyclic structure even though the melting point of the molecule itself is low so that the molecular mobility of the linear-chain hydrocarbon as the first component of the releasing agent and the branched-chain hydrocarbon wax contained in the second component of the releasing agent is inhibited by the molecular entanglement of them. As a result of that, the melting of the low molecular weight linear-chain hydrocarbon wax caused by the thermal energy generated by slipping stress with the carrier is inhibited and the wholly transfer of the releasing agent to the carrier surface is inhibited so that the contamination of the carrier is inhibited.

As another reason, the followings can be considered.

The stress given from the carrier to the toner can be minimized by that the shape coefficient SF-1 of the carrier is within the range of from 1.0 to 1.2. The carrier donates triboelectricity to the toner by touching and rubbing together with the toner. In such the situation, the surface of the toner is worn out on the occasion of charging by rubbing when the shape of the carrier is irregular since the projected portion of the carrier particle affects as a slipping stress donating portion to the toner. As a result of that, the ingredient of the toner surface is easily transferred to the carrier. Such the phenomenon can be inhibited by minimizing that the slipping stress given from the carrier to the toner by making the shape coefficient SF-1 to the value within the above range. On the other hand, the charge donating ability of the carrier is lowered when the shape of the carrier is made true sphere such as 1.0 to 1.2 in the shape coefficient SF-1 since the portions contributing for triboelectricity are reduced. Such the problem can be solved and sufficient triboelectricity donating ability can be obtained by suitably making the irregularity of the carrier such as 1.1 to 2.5 in the shape coefficient SF-2 so as to form fine irregular portions on the carrier surface.

The stress donated from the carrier to the toner can be reduced by reducing the collision energy of the carrier it self by making the volume based median diameter of the carrier to a value of from 10 to 100 μm.

A carrier internally containing no resin constituted only by ferrite particles of iron particles cannot absorb and mitigate the stress because the interior structure thereof is very hard. It is supposed that the high durability of the carrier can be obtained by constituting the carrier by the resin dispersed type carrier such as that of the invention because the interior of which is made relatively soft and the stress to the toner can be mitigated by the carrier itself. The collision energy on the occasion of contacting the toner with the carrier is reduced and the generated stress is mitigated by the carrier by the use of the above carrier. As a result of that the transfer of the releasing agent of the toner to the carrier by such the force may be inhibited.

As above-mentioned, it is supposed that the carrier contamination is sufficiently inhibited by absorbing the stress at the time of contacting the toner with the carrier can be reduced by the constitution of the toner additionally to the inhibition of the releasing agent to the carrier surface by the structure of the releasing agent itself.

The double-component developer of the invention is described in detail below.

The double-component developer of the invention is a developer comprising the toner containing the specified releasing agent described in detail below and the resin dispersed type carrier having the specified shape, hereinafter also referred to as the specified resin dispersed type carrier.

### (Toner)

The toner constituting the double-component developer of the invention contains at least a binder resin, a colorant and the releasing agent, and the releasing agent contains from 10 to 95%, and preferably from 90 to 40%, by weight of the first releasing agent component constituted by a linear hydrocarbon compound having a melting point of from 50 to 100° C. and from 5 to 90, and preferably from 10 to 609%, by weight of the second releasing agent component comprising a hydrocarbon compound having a branched-chain structure and a melting point of from 50 to 100° C. The hydrocarbon compound having a branched-chain structure includes that having cyclic structure.

The toner can be fixed with sufficient fixation strength by the low temperature fixation and the interaction caused by molecular entanglement of the branched-hydrocarbon type wax with the linear-hydrocarbon can be sufficiently obtained when the ratio of the first releasing agent component and the second releasing agent component is within the above range so that the transfer of the releasing agent can be totally inhibited.

Containing ratio of the first and the second releasing agent components can be regarded as the ratio on the occasion of addition. When the ratio is measured as to the toner, the ratio can be calculated from the ratio of the tertiary and quaternary carbon atoms derived from the branched-hydrocarbon (the later-mentioned ratio of the branch) in the whole releasing agent and the previously measured ratio of the branch contained in the branched-hydrocarbon itself.

### (Linear Hydrocarbon Compound)

For the linear-hydrocarbon compound as the first releasing agent component constituting the releasing agent, a petroleum wax such as paraffin wax and a synthesized wax such as Fischer-Tropsch wax and polyethylene wax are usable.

The paraffin wax is a wax separated from reduced pressure distillated oil.

The Fischer-Tropsch wax is hydrocarbon compound having from 16 to 78 carbon atoms obtained from distillation residue of the hydrocarbon compound synthesized from synthetic gas composed of carbon monoxide and hydrogen or a hydrogenation product of the distillation residue.

The polyethylene wax is a wax synthesized by polymerization of ethylene or thermal decomposition of polyethylene.

As the linear-hydrocarbon compound in the invention, one is preferable which has a weight average molecular weight of from 300 to 600 and, particularly, a number average molecular weight of from 300 to 500 and more preferably from 400 to 500. The ratio of the weight average molecular weight to the number average molecular weight Mw/Mn is preferably from 1.0 to 1.20.

As the first releasing agent component constituting the releasing agent, two or more kinds of the linear-hydrocarbon compounds may be used in combination.

### (Branched Chain-Hydrocarbon Wax)

The branched chain-hydrocarbon wax as the second releasing agent component constituting the releasing agent includes a cyclic hydrocarbon wax in which the branched hydrocarbon groups form a cyclic structure. The branched chain-hydrocarbon wax preferably has a ratio of branch of from 0.1 to 20% and more preferably from 0.3 to 1.0%. The ratio of branch, namely the ratio of the sum of tertiary carbon atoms and the quaternary carbon atoms in the whole carbon atoms is a value obtained by the following method.

The branched chain-hydrocarbon wax may be a mixture of the branched chain hydrocarbon compound with a hydrocarbon compound having no branch structure, i.e., linear-chain hydrocarbon compound.

When the ratio of the tertiary carbon atoms and the quaternary carbon atoms to the whole carbon atoms constituting the branched chain-hydrocarbon type wax is within the range of from 0.1 to 20%, molecular entanglement by the interaction with the linear-hydrocarbon compound can be surly obtained and the transfer of the releasing agent to the carrier is made difficult.

The ratio of the branch in the branched chain-hydrocarbon type wax can be calculated by the following Formula (i) from the spectrum obtained by a method of 13C-NMR measurement under the following conditions.

Ratio of branch(%)=(C3+C4)/(C1+C2+C3+C4)×100 Formula (i)

In the above Formula (i), C3 is the peak area relating to the tertiary carbon atoms, C4 is the peak area relating to the quaternary carbon atoms, C1 is the peak area relating to the primary carbon atoms, and C2 is the peak area relating to the secondary carbon atoms.

### (Conditions of 13C-NMR Measuring Method)

Measuring apparatus: FT NMR apparatus Lambda 400 manufactured by Nihon Denshi Co., Ltd.

Measuring frequency: 100.5 MHz

Pulls condition: 4.0 μs

Data points: 32768

Delay time: 1.8 sec.

Frequency range: 27100 Hz

Multiplying times: 20,000

Measuring temperature: 80° C.

Solvent: Benzene-d⁶%-dichlorobenzene-d⁴=¼ (v/v)

Sample concentration: 3% by weight

Diameter of sample tube: 5 m

Measuring mode: 1H completely decoupling method

Examples of the branched chain-hydrocarbon type wax include microcrystalline wax such as HNP-0190, Hi-Mic-1045, Hi-Mic-1070, Hi-Mic-1080, Hi-Mic-1090, Hi-Mic-2045, Hi-Mic-2065 and Hi-Mic-2095, and Wax EMW-0001 and EMW-0003 principally composed of isoparaffin, each manufactured by Nihon Seirou Co., Ltd.

The microcrystalline wax is, different from the paraffin wax principally composed of linear-chain hydrocarbon (normal paraffin), a wax having higher content of branched chain-hydrocarbon (iso paraffin) and cyclic hydrocarbon (cycloparaffin) among the petroleum paraffin. The microcrystalline wax is smaller in the crystal sized and larger in the molecular weight than those of paraffin wax because the microcrystalline wax contains much low crystalline isoparaffin and/or cycloparaffin. Such the microcrystalline wax has a carbon number of from 30 to 50, a weight average molecular weight of from 500 to 800 and a melting point of from 60 to 90° C.

As the microcrystalline wax constituting the branched-chain hydrocarbon type wax, one having a weight average molecular weight of from 600 to 800 and a melting point of from 60 to 85° C. is preferred. One with low molecular weight having a number average of from 300 to 800 is preferable and one having that of from 400 to 800 is more preferable. The ratio of the weight average molecular weight to the number average molecular weight Mw/Mn is preferably from 1.01 to 1.20.

### (Production Method of Branched Hydrocarbon Type Wax)

As the method for obtaining such the branched hydrocarbon type wax, two methods are applicable such as a press sweating method by which the hydrocarbon compound solidified by holding raw material oil at specific temperature is separated and taken out and a solvent extract method by which a solvent is added to raw material oil which is reduced pressure distillation residue oil or heavy distillated component of petroleum for solidifying the objective component and the solidified substance is filtered. Among them, the later solvent extract method is preferred. The branched hydrocarbon type wax obtained by the above method may be purified using sulfate clay since the product is colored.

As the secondary releasing agent component, two or more kinds of the hydrocarbon compound having the above branched chain structure and/or cyclic structure can be used.

The whole adding amount of the releasing agent is preferably from 1 to 30%, and more preferably from 5 to 20%, by weight of the later-mentioned binder resin.

In the releasing agent relating to the double-component developer of the invention, the melting point of the first releasing agent component is within the range of from 50 to 100° C. and preferably from 55 to 90° C. and that of the second releasing agent component is within the range of from 50 to 100° C., and preferably from 55 to 90° C., and the melting point of the whole releasing agent is, for example, from 50 to 100° C., preferably 60 to 100° C., and more preferably from 65 to 85° C.

The melting point of the releasing agent is expressed by the temperature at the summit of the endothermic peak of the releasing agent, and can be measured by using, for example, a differential scanning calorimeter DSC-7, manufactured by PerkinElmer Co., Ltd., and a thermal analysis controller TAC7/DX, manufactured by PerkinElmer Co., Ltd. In concrete, 4.00 mg of the releasing agent is exactly weighed to two places of decimal and enclosed in an aluminum pan KITON 0219-0041 and set on the sample holder of DSC-7 and subjected to Heat-cool-Heat temperature control under conditions of a measuring temperature of from 0 to 200° C., a temperature raising rate of 10° C./min. and a temperature lowering rate of 10° C./min., and analysis is carried out according to the data obtained at the second heating. An empty pan is subjected to measurement for reference.

### (Production Method of Toner)

For producing such the toner, known methods such as a crushing method, a suspension polymerization method, a mini-emulsion polymerization method, an emulsion polymerization method, a dissolving-dispersing method and a polyester molecule prolongation method are available without any limitation.

### (Suspension Polymerization Method)

The suspension polymerization method is carried out as follows. Toner constituting materials such as the releasing agent, the colorant and a radical polymerization initiator are added to a radical polymerizable monomer and dissolved or dispersed in the monomer by a sand grinder to prepare uniform monomer dispersion. After that, the above monomer dispersion is added into an aqueous medium, in which a dispersion stabilizer is previously added, and dispersed by a homomixer or an ultrasonic wave disperser to form oil droplets in the aqueous dispersion. The particle diameter of the droplet finally becomes the diameter of the toner particle. Therefore, the dispersing is controlled so that the diameter is made to desired size. The size of the dispersed droplet is preferably from 3 to 10 μm in the volume based median diameter. Thereafter, polymerization is performed by heating. After completion of the polymerization reaction, the dispersion stabilizer is removed and the resultant polymerized product is washed and dried to obtain colored particles. And then an external additive is added and mixed according to necessity. Thus toner particles can be obtained.

When toner particles constituting the toner are produced by the crushing method or the dissolving suspension method, various kinds of known resin, for example, a vinyl type resin such as a styrene type resin, a (meth)acryl type resin, a styrene-(meth)acryl type copolymer resin, an olefin type resin, a polyester type resin, a polyamide type resin, a polycarbonate type resin, a polyether type resin, a poly(vinyl acetate) resin, a polysulfone resin, an epoxy resin, a polyurethane resin and a urea resin are usable as the binder resin for constituting the toner. These resins can be used singly or in combination of two or more kinds of them.

The releasing agent and the colorant are added to the resin and kneaded by a bi-axial kneader, crushed and classified. Thus the toner particles can be obtained.

When the toner particles are prepared by the suspension polymerization method, mini-emulsion polymerization-coagulation method or emulsion polymerization-coagulation method, for example, the following can be used as the polymerizable monomer for forming the resin to obtain the resin for constituting the toner: A vinyl type monomer, for example, styrene or a styrene derivative such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene p-n-nonylstyrene, p-n-decylstyrene and p-n-dodecylstyrene; a methacrylate derivative such as methyl methacrylate, ethyl methacrylate, n-butyl methacrylate, iso-propyl methacrylate, iso-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate and phenyl acrylate; an olefin such as ethylene, propylene and iso-butylene, a vinyl halide such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinyl pyrrolidone; a vinyl compound such as vinylnaphthalene and vinylpyridine; and an acrylic acid or a methacrylic acid derivative such as acrylonitrile and acrylamide. These vinyl type monomers may be used singly or in combination of two or more kinds of them.

Moreover, a monomer having an ionic dissociable group is preferably used in combination with the above resin. The polymerizable monomer having an ionic dissociable group is one having a substituent such as a carboxyl group, a sulfonic acid group or a phosphoric group; concretely acrylic acid, methacrylic acid, maleic acid, itaconic acid, cinnamic acid, fumaric acid, a mono-alkyl maleate, a mono-alkyl itaconate, styrenesulfonic acid, allyl sulfosuccinate, 2-acrylamide-2-methylpropanesulfonic acid, acid phosphoxyethyl methacrylate and 3-chloro-2-acid phosphoxypropyl methacrylate are cited.

Furthermore, binder resins having crosslinked structure can be obtained by using a multifunctional vinyl compounds as the polymerizable monomer; concrete examples are divinylbenzene, ethylene glycol dimethacrylate, diethylene glycol diacrylate, diethylene glycol dimethacrylate, diethylene glycol diacrylate, triethylene glycol diacrylate, neopentyl glycol dimethacrylate and neopentyl glycol diacrylate.

### (Surfactant)

When the toner particle constituting the toner is prepared by the suspension polymerization method, mini-emulsion method or the emulsion polymerization, the surfactant usable for obtaining the binder resin is not specifically limited. Ionic surfactants, for example, a sulfonic acid salt such as sodium dodecylbenzenesulfonate and sodium aryl-alkyl polyether sulfonate, sulfuric acid ester salt such as sodium dodecylsulfate, sodium tetradecylsulfate, sodium pentadecylsulfate, sodium pentadecylsulfate and sodium octylsulfate, a fatty acid salt such as sodium oleate, sodium laurate, sodium caprate, sodium caprylate, sodium capronate, potassium stearate and calcium oleate can be cited as suitable examples. A nonionic surfactant such as polyethylene oxide, polypropylene oxide, a combination of polypropylene oxide and polyethylene oxide, an ester of polyethylene glycol and a higher fatty acid, an alkylphenol polyethylene oxide, an ester of higher fatty acid and polypropylene oxide and a sorbitan ester is also usable. These surfactants are used as an emulsifying agent when the toner is produced by the emulsion polymerization but they may be used for another process and another purpose.

### (Dispersion Stabilizer)

When the toner particles constituting the toner are produced by the suspension polymerization method, an easily removable inorganic compound may be also used as the dispersion stabilizer. As the dispersion stabilizer, tricalcium phosphate, magnesium hydroxide and hydrophilic colloidal silica can be exemplified, and tricalcium phosphate is particularly preferred. The dispersion stabilizers can be easily decomposed by an acid such as hydrochloric acid and easily removed from the surface of toner particle.

### (Polymerization Initiator)

In the case of the suspension polymerization, an oil soluble radical polymerization initiator can be used. Examples of oil-soluble polymerization initiator include an azo type or diazo type polymerization initiator such as 2,2′-azobis-(2,4-dimethylvaleronitrile), 2,2′-azobis-isobutyl nitrile, 1,1′-azobis(cyclohexane-1-carbonitrile), 2,2′-azobis-4-methoxy-2,4-dimethylvaleronitrile and azobisisobutyronitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof.

### (Chain-Transfer Agent)

When the toner particles are produced by the suspension polymerization method, mini-emulsion method or emulsion polymerization method, usually used chain-transfer agent can be used for controlling the molecular weight of the binder resin.

As the chain-transfer agent, for example, a mercaptan such as n-octyimercaptan, o-decylmercaptan and tert-dodecylmercaptane, an aster of n-octyl-3 mercaptopropionic acid, terpinolene, carbon tetrabromide and α-methylstyrene dimer are usable, without any limitation.

### (Colorant)

As the colorant constituting the toner, known inorganic and organic colorants can be used. Concrete colorants are listed below.

As a black colorant, carbon black such as furnace black, channel black, acetylene black, thermal black and lamp black, and a magnetic powder such as magnetite and ferrite are exemplified.

As a magenta or red colorant, I. C. Pigment Red 2, I. C. Pigment Red 3, I. C. Pigment Red 5, I. C. Pigment Red 6, I. C. Pigment Red 7, I. C. Pigment Red 15, I. C. Pigment Red 16, I. C. Pigment Red 48:1, I. C. Pigment Red 53:1, I. C. Pigment Red 57:1, I. C. Pigment Red 122, I. C. Pigment Red 123, I. C. Pigment Red 139, I. C. Pigment Red 144, I. C. Pigment Red 149, I. C. Pigment Red 166, I. C. Pigment Red 177, I. C. Pigment Red 178 and I. C. Pigment Red 222 are exemplified.

As an orange or yellow colorant, I. C. Pigment Orange 31, I. C. Pigment Orange 43, I. C. Pigment Yellow 12, I. C. Pigment Yellow 13, I. C. Pigment Yellow 14, I. C. Pigment Yellow 15, I. C. Pigment Yellow 74, I. C. Pigment Yellow 93, I. C. Pigment Yellow 94 and I. C. Pigment Yellow 138 are exemplified.

As a green or blue colorant, I. C. Pigment Blue 15, I. C. Pigment Blue 15:2, I. C. Pigment Blue 15:3, I. C. Pigment Blue 15:4, I. C. Pigment Blue 16, I. C. Pigment Blue 60, I. C. Pigment Blue 62, I. C. Pigment Blue 66 and I. C. Pigment Green 7 are exemplified.

The above colorants may be used singly or in combination of two or more kinds thereof. The adding amount of the colorant is from 1 to 30%, and preferably from 2 to 20%, by weight of the whole weight of the toner.

The colorant modified on the surface thereof may be used. As the surface modifying agent, a silane coupling agent, a titanium coupling agent and an aluminum coupling agent are preferably usable.

### (Charge Controlling Agent)

A charge controlling agent may be contained in the toner particle constituting the toner according to necessity. Known various compounds can be used as the charge controlling agent.

### (Diameter of Toner Particle)

The diameter of the toner particle is preferably from 3 to 10 μm in volume based median diameter. The particle diameter can be controlled by controlling the diameter of the dispersed oil droplet when the toner particle is formed by the suspension polymerization method.

When the volume based median diameter is within the range of from 3 to 10 μm, high reproducibility of fine lines and high quality of photographic images can be obtained, and the consumption of the toner can be reduced comparing with a toner having large diameter. The volume based median diameter of the toner particle can be determined by using the particle distribution within the range of from 2.0 to 40 μm measured by Coulter Multisizer, manufactured by Coulter Co., Ltd., using a aperture of 50 μm.

### (External Additive)

A material so called as external additive may be added to the toner for improving the fluidity, electroconductivity and cleaning suitability. The external additive is not specifically limited and various kinds of inorganic fine particle, organic particle and a slipping agent can be used.

As the inorganic particle, fine particle of silica, titania or alumina are preferably used and the inorganic particles are preferably subjected to hydrophobicity providing treatment by a silane coupling agent or a titanium coupling agent. As the organic fine particle, spherical one having a number average primary particle diameter of approximately from 10 to 2,000 nm can be used. The organic fine particle of polymer such as polystyrene, poly(methyl methacrylate) or a copolymer of styrene-methyl methacrylate is usable.

The adding ratio of the external additives is from 0.1 to 5.0%, and preferably from 0.5 to 4.0%, by weight of the toner. Various kinds of material may be used in combination as the external additive.

### (Carrier)

The carrier constituting the developer is the specified resin dispersion type carrier comprising a binder resin in which magnetic fine particles are dispersed and the carrier has a shape coefficient SF-1 of from 1.0 to 1.2 and a shape coefficient SF-2 of from 1.1 to 2.5 and a volume based median diameter of from 10 to 100 μm.

### (Magnetic Fine Particle)

As the magnetic fine powder constituting the specific resin dispersion type carrier, fine powder of known magnetic material, for example, a metal such as iron, or metal oxide such as ferrite represented by Formula a): MO.Fe₂O₃, magnetite represented by Formula b): MFe₂O₄, an alloy of such the metal or metal oxide with a metal such as aluminum and lead can be used. In the above Formulas a) and b), M is a di- or mono-valent metal such as Mn, Fe, Ni, Co, Cu, Mg, Zn, Cd and Li which can be used singly or in combination of plural kinds of them.

As the concrete magnetic fine powder, magnetite, γ-iron oxide, Mn—Zn type ferrite, Ni—Zn type ferrite, Ca—Mg type ferrite, Li type ferrite and Cu—Zn type ferrite can be exemplified.

The content of the magnetic fine powder in the specified resin dispersion carrier is from 40 to 99%, and preferably from 50 to 70%, by weight based on the carrier.

The number average primary particle diameter of the magnetic fine particle is preferably from 0.1 to 0.5 μm. The number average primary particle diameter is arithmetic average of FERE direction diameter of 100 magnetic particles measured on the electron microscopic photograph with a magnification of 10,000.

A non-magnetic metal oxide powder using single or plurality of non-magnetic metal such as Mg, Al, Si, Ca, Sc, Ti, V, Cr, Mn, Fe, Co, Sr, Y, Zr, Mb, Me, Cd, Sn, Ba and Pb can be used together with the above magnetic fine powder for controlling the magnetic properties. As the concrete examples of the non-magnetic metal oxide, Al₂O₃, SiO₂, CaO, TiO₂, V₂O₅, CrO₂, MnO₂, Fe₂O₃, CoO, NiO, CuO, ZnO, SrO, Y₂O₃ and ZrO₂ are cited.

The number average primary particle diameter of the non-magnetic metal oxide powder is preferably from 0.1 to 1.0 μm.

The content of the non-magnetic metal oxide powder in the resin dispersion type carrier is from 10 to 60%, and preferably from 20 to 4096, by weight.

The magnetic fine powder may be subjected to a lyophilizing treatment by a lyophilizing agent such as various kinds of coupling agent and higher fatty acids for raising lyophilicity and hydrophobicity.

The adding amount of the lyophilizing agent is preferably from 0.1 to 10, and more preferably from 0.2 to 6, parts by weight par 100 parts by weight of the magnetic powder.

### (Binder Resin)

Known resins can be used as the binder resin constituting the specified resin dispersion type carrier without any limitation. Concretely, various kinds of resin such as a styrene-acryl type resin, a polyester resin, a fluororesin, a phenol-formaldehyde resin, an epoxy resin, a urea resin, a melamine resin are available, and the phenol-formaldehyde resin is particularly preferred.

As the binder resin, a thermally curable resin capable of forming partially or wholly constituting three dimensionally cross linking is preferably used, by which peeling off of the binder resin and releasing of the magnetic pine particle from the carrier can be inhibited by net work formed in the resin itself. Namely, the hardness and the durability of the carrier can be raised by the use of such the crosslinkable binder resin. Therefore, the binder resin constituting the carrier is not peeled off and not transferred onto the toner so that the surface of the is not contaminated even when the image formation is repeated for many times and when the carrier is collide with the toner.

### (Production Method of Carrier)

The specified resin dispersion carrier can be produced by a method so called polymerization method.

The specified resin dispersion type carrier produced by the polymerization method has shape of near true sphere so that the carrier contamination is inhibited and uniformity of the surface and high charge donating ability can be obtained. The shape of the carrier can be easily controlled on the occasion of the production.

When the binder resin constituting the specified resin dispersion type carrier is phenol-formaldehyde resin, for example, the carrier can be obtained by adding and dissolving or dispersing a phenol and an aldehyde as the raw material monomers and the magnetic fine particles into an aqueous medium which contains the dispersion stabilizer such as colloidal tricalcium phosphate, magnesium hydroxide and hydrophilic silica, and subjected to polymerization (addition condensation reaction) treatment in the presence of a basic catalyst.

In similar manner, a melamine resin can be obtained by using melamine and an aldehyde as the raw material monomers, an epoxy resin can be obtained by using a bisphenol and epichlorohydrin as the raw material monomers and no basic catalyst, and a urea resin can be obtained by using urea and an aldehyde as raw material monomers and no basic catalyst.

As the basic catalyst to be used when the binder resin is the phenol-formaldehyde resin or the melamine resin, for example, ammonia water, and an alkylamine such as hexamethylenetetramine, dimethylamine, diethyltriamine and polyethyleneimine are applicable. The basic catalyst is preferably added in an amount of from 0.02 to 0.3 moles per mole of the phenol.

As the phenols to be used when the binder resin is the phenol-formaldehyde resin, an alkyl phenol such as phenol, m-cresol, p-tert-butylphenol, o-propylphenol, resorcinol and bisphenol A and a halogenated phenol such as one in which a part or whole of the alkyl group or the benzene ring is substituted by a chlorine atom or a bromine atom are applicable. Phenol is particularly preferable since high particle shape forming ability can be obtained.

As the aldehyde to be used when the binder resin is the phenol-aldehyde rein, formaldehyde in a form of formalin or paraformaldehyde and furfural are applicable, and formaldehyde is preferred.

The specified resin dispersion carrier also can be produced by a method so called suspension polymerization method. Namely, the binder resin can be obtained by that the magnetic fine powder is dispersed in a radial polymerizable monomer and a radical polymerization initiator was added to the resultant dispersion to prepare a carrier producing composition, and then the composition is dispersed into a form of oil droplets in an aqueous medium which contains the dispersion stabilizer such as colloidal tricalcium phosphate, magnesium hydroxide and hydrophilic silica and preferably small amount of an anionic surfactant, and then subjected to radical polymerization treatment. The diameter of the oil droplet on the occasion of dispersion is from 10 to 100 μm, and preferably from 15 to 80 μM, in volume based median diameter. The particle diameter on the occasion of dispersion becomes the particle diameter of the resultant specified resin dispersion type carrier.

### (Radical Polymerizable Monomer)

As the radical polymerizable monomer for obtaining the specified resin dispersion type carrier by the suspension polymerization method, the followings are cited: A vinyl type monomer, for example, styrene and its derivative such as styrene, o-methylstyrene, m-methylstyrene, p-methylstyrene, α-methylstyrene, p-chlorostyrene, 3,4-dichlrostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene; a methacrylate derivative such as methyl methacrylate, ethyl methacrylate, n-butyl methacrylate, isopropyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate; an olefin compound such as ethylene, propylene and isobutylene; a vinyl halide compound such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinylpyridine; a derivative of acrylic acid or methacrylic acid such as for example, acrylonitrile, methacrylonitrile and acrylamide. These vinyl type monomers can be used singly or in combination of two or more kinds of them.

### (Radical Polymerization Initiator)

As the radical polymerization initiator to be used for producing the specified resin dispersion type carrier by the suspension polymerization method, an oil-soluble initiator, for example an azo type or diazo type polymerization initiator such as 2,2′-azobis-(2,4-dimethylvaleronitrile), 2,2′-azobis-isobutylnitrile, 1,1′-azobis(cyclohexane-1-carbonitrile), 2,2′-azobis-4-methoxy-2,4-dimethylvaleronitrile and azobis-isobutyronitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof are applicable.

### (Chain-Transfer Agent)

Usually used chain-transfer agent may be contained in the carrier polymerizing composition for controlling the molecular weight of the binder resin constituting the specified resin dispersion type carrier.

As the chain-transfer agent, for example, a mercaptan such as n-octylmercaptan, o-decylmercaptan and tert-dodecylmercaptane, an aster of n-octyl-3 mercaptopropionic acid, terpinolene, carbon tetrabromide and α-methylstyrene dimer are usable, without any limitation.

In the invention, the specified resin dispersion carrier may be one coated on the surface thereof by a suitable resin selected for suiting the charging amount of the toner to obtain the optimum charging property and charging amount, and high durability.

When the carrier particle is coated with the coating resin, the amount of the coating resin is preferably from 0.1 to 10%, and more preferably from 0.3 to 5%, by weight of the carrier particles to be the core of the resin coated carrier particles.

The coated amount and the state of the coating resin should be controlled so that the shape coefficients SF-1 and SF-2 are each made to the foregoing values, respectively.

A thermoplastic or thermally curable insulating resin is suitably used as the coating resin. Concrete examples of the thermoplastic insulating resin include an acryl resin such as polystyrene, a copolymer of poly(methyl methacrylate) and a styrene-acrylic acid, a styrene-butadiene copolymer, vinyl chloride, vinyl acetate, poly(vinylidene fluoride) resin, fluorocarbon resin, perfluorocarbon resin, solvent-soluble perfluorocarbon resin, poly(vinyl alcohol), poly(vinyl acetal), polyvinylpyrrolidone, a petroleum resin, a cellulose derivative such as cellulose, cellulose acetate, cellulose nitrate, methyl cellulose, hydroxymethyl cellulose and hydroxypropyl cellulose, a novolak resin, low molecular weight polyethylene, an aromatic polyester resin such as a saturated alkyl polyester resin, poly(ethylene phthalate), poly(butylene phthalate) and polyallylate, polyamide resin, polyacetal resin, polysulfone resin, polyphenylene sulfide resin and poly(ether ketone) resin.

Examples of the thermally curable insulating resin include phenol resin, a modified phenol resin, a maleic resin, an alkyd resin, an epoxy resin and an acryl resin, in concrete, an unsaturated polyester formed by condensate polymerization of maleic anhydride-terephthalic acid-polyvalent alcohol, urea resin, melamine resin, xylene resin, toluene resin, guanamine resin, melamine-guanidine resin, acetoguanamine resin, Glyptal resin, furan resin, silicone resin, polyimide, polyamideimide resin, polyetherimide resin and polyurethane resin.

These coating resins may be used singly or in combination of two or more kinds of them. Moreover, it is allowed that a curing agent is mixed in the thermoplastic insulating resin for curing the coated resin.

The method for coating such the coating resin on the specified resin dispersion type carrier particle as the core particle, a method in which a coating liquid is prepared by dissolving or dispersing the coating resin in an organic solvent and the liquid is coated on the carrier particle, and a method in which powder of the coating resin and the carrier particles are mixed to adhere the resin onto the carrier particles, are applicable.

The carrier constituting the double-component developer is composed of the carrier particle having a shape coefficient SF-1 of 1.0 to 1.1 and a shape coefficient SF-2 of 1.1 to 2.5.

The shape coefficient SF-1 is an index indicating the spherical degree and is 1 when the particle is truly sphere. The shape coefficient SF-2 is an index indicating the degree of fine irregularity of the surface of carrier particle, and is 1 when the surface is smooth without any irregularity.

The stress giving from the carrier to the toner can be minimized when the shape coefficient is within the range of from 1.0 to 1.2. When the shape of the carrier particle is irregular, the projected portion of the particle affects as the slipping stress donating portion to the toner so that the toner surface is worn and the component of the toner surface tends to be transferred to the carrier on the occasion of frictional electrification of the toner. However, the slipping stress from the carrier to toner can be minimized by making the shape coefficient SH-1 to value within the above range.

When the shape of the carrier is true sphere such as that the shape coefficient SF-1 is from 1.0 to 1.2, the portion contributing for generating triboelectricity is reduced and the charge donating ability to the toner is lowered. However, sufficient charge donating ability to the toner can be obtained by giving suitable irregularity or fine unevenness to the surface so that the shape coefficient is made to a value of from 1.1 to 2.5.

### (Shape Coefficient of Carrier)

The shape coefficients SF-1 and SF-2 can be determined by randomly taking magnified photograph of 100 particles of the carrier by a field emission scanning electron microscope S-4500, manufactured by Hitachi Ltd., and analyzing the photograph by an image processing analyzing apparatus LUZEX 3, manufactured by Nireco Corporation and then calculating the average values derived from the following Formulas (SF-1) and (SF-2).

SF-1={(MXLNG)²/(AREA)}×(π/4) Formula (SF-1)

SF-2={(PERI)²/(AREA)}×(¼π) Formula (SF-2)

In the above Formulas (SF-1) and (SF-2), MXLNG is the largest diameter of the carrier particle, AREA is the projection area of the carrier particle and PERI is the circumference length of the carrier particle.

The largest diameter is the width of the carrier particle for making largest the distance of a pair of parallel lines when the particle is put between these lines. The projection area is an area of the image of the carrier particle projected on a plane.

### (Particle Diameter of Carrier)

The specified resin dispersion type carrier constituting the double-component of the invention has a volume based median diameter of from 10 to 100 μm, and preferably from 15 to 80 μm. The volume based median diameter of the specified resin dispersion type carrier can be typically measured by a laser diffraction type particle size distribution measuring apparatus HEROS, manufactured by Sympatec Co., Ltd., having a wet type dispersing device.

When the volume based median diameter of the specified resin dispersion type carrier is less than 10 μm, the ratio of fine particles in the distribution of carrier particles and easily image wise adheres to the photoreceptor because the magnetic force per particle is lowered. When the volume based median diameter of the specified resin dispersion type carrier exceeds 100 μm, scattering of the toner is caused because the specific surface area of the carrier particle is reduced and the toner holding force is lowered.

The magnetization strength of the specified resin dispersion type carrier is preferably of from 20 to 300 emu/cm³ in a magnetic field of 1 kOe.

The ratio of the toner in the double-component developer of the invention is from 3 to 20%, and preferably from 4 to 15%, by weight of the double-component developer.

### (Image Forming Method)

A usual developing method can be applied without any specific limitation to the image formation using the double-component developer of the invention. Both of a contact and non-contact developing systems can be applied.

The double-component developer of the invention is suitably applied for systems so called toner recycle system in which the toner remaining on the photoreceptor is recovered and returned to the developing apparatus and reused because the developer is difficulty subjected to stress.

Moreover, the double-component developer of the invention can be suitably applied for forming full color images since the developer is low in the degradation thereof and the development can be stably performed for long period. In such the case, both of an image forming method by a four-cycle system constituted by four developing devices each relating to each of yellow, magenta, cyan and black, respectively, and one photoreceptor, and an image forming method by a tandem system in which image forming units each constituted by one color developing device and one photoreceptor are used for each of the colors can be applied.

When the double-component developer of the invention is applied for the full color image formation, the development can be stably performed for long period so that the color of the resultant color image can be stably maintained for long period.

### (Fixing Method)

The double-component developer of the invention is suitably used for image forming method using a fixation system such as a heat-pressing fixing system, a heating roller fixation system and a contact-heating system in which the fixation is carried out by a rotatable pressing member including a fixedly provided heater.

Particularly, the developer is suitably applied for an image forming method in which the fixation is carried out at a relatively low surface temperature of from 100 to 200° C., and preferably from 120 to 180° C., in concrete, at a surface temperature of the fixing member at the nipping portion of from 120 to 200° C., even though the temperature is varied depending to the transferring material.

### (Transferring Material)

In the above image forming method, ordinary paper having thickness of from thin to thick, high quality paper, coated paper for printing such as art paper and coat paper, Japanese paper and post card paper available on the market, plastic film for OHP and close are usable as the transferring material on which an image is formed, but the material is not limited to the above.

By the above-described double-component developer, a fixed image with sufficient strength by the low temperature fixation can be obtained even though the releasing agent wholly has low melting point since the releasing agent contained in the toner is composed of the specified mixture. Moreover, the carrier is composed of the resin dispersion type carrier having the specified shape additionally to that the releasing agent is the specified mixture and the resin dispersion type carrier has high durability. Consequently, the contamination of the carrier is inhibited for long period so that the toner is charged with high uniformity. As a result of that, images having high quality can be stably formed for long period.

### EXAMPLES

Examples carried out for confirming the effects of the invention are described below, but the invention is not limited to the examples.

### Carrier Producing Example 1

To each of magnetite (FeO.Fe₂O₃) powder having a number average primary particle diameter of 0.24 μm and α—Fe₂O₃ powder having a number average primary average diameter of 0.60 μm, 0.55% by weight of a silane coupling agent (3-(2-aminoethylaminopropyl)dimethoxysilane) was added, respectively, and rapidly stirred at 100° C. in a stirring vessel for lyophilizing the each of the metal oxide fine particles to prepare oleophilic magnetite powder A and oleophilic α-iron oxide powder A.

Composition (1) composed of 60 parts by weight of the oleophilic magnetite powder A, 40 parts by weight of oleophilic α-iron oxide powder A, 10 parts by weight of phenol and 6 parts by weight of a formaldehyde solution containing 40% by weight of formaldehyde, 10% by weight of methanol and 50% of water was added to a flask containing an aqueous medium containing 28% by weight of NH₄OH aqueous solution and heated by 85° C. spending for 40 minutes while stirring and subjected to thermally curing reaction for 3 hours while maintaining at this temperature and then cooled by 30° C. Water was further added and the supernatant was removed and remaining precipitate was washed by water, dried by air and further dried under reduced pressure of not more than 50 mmHg at 60° C. to obtain Carrier Particle (a).

A toluene coating solution containing 10% by weight of silicone resin was prepared and the coating solution was coated on Carrier Particles (a) as the core by evaporating the solvent while continuously applying shearing stress to the coating solution so that the coated amount of the resin was 1.0% by weight. After that, the coated layer was cured for 1 hour at 200° C. and loosed, and then classified by a sieve of 20 meshes to obtain specified resin dispersion type Carrier A coated with silicone resin on the surface thereof.

The specified resin dispersion type Carrier A had a volume based median diameter of 34 μm, a shape coefficient SF-1 of 1.04 and a shape coefficient SF-2 of 1.51. The strength of magnetization at 1 kOe was 129 emu/cm³.

The volume based median diameter was measured by the laser diffraction type particle size distribution measuring apparatus HEROS, manufactured by Sympatec Co., Ltd., having a wet type dispersing device, and the shape coefficients SF-1 and SF-2 were determined by randomly taking magnified photograph of 100 particles of the carrier by a field emission scanning electron microscope S-4500, manufactured by Hitachi Seisakusho Co., Ltd., and analyzing the photograph by an image processing analyzing apparatus LUZEX 3, manufactured by Nireco Corporation, and then calculating the average values derived from the following Formulas (SF-1) and (SF-2). The strength of magnetization was measured by a vibration magnetic field type automatic magnetic property recording apparatus BHV-30, manufactured by Riken Denshi Co., Ltd.

### Carrier Production Example 2

Carrier Particle (b) was obtained in the same manner as in Carrier Producing Example 1 except that Composition (2) composed of 100 parts by weight of oleophilic magnetite powder A, 10 parts by weight of phenol and 6 parts by weight of a formaldehyde solution composed of 40% by weight of formaldehyde, 10% by weight of methanol and 50% of water was used in place of Composition (1). The specified resin dispersion type Carrier B was prepared in the same manner as in Carrier Producing Example 1 except that the amount of the coated resin is varied to 1.5% by weight. The specified resin dispersion type Carrier B had a volume based median diameter of 39 μm, a shape coefficient SF-1 of 1.10 and a shape coefficient SF-2 of 1.15. The strength of magnetization at 1 kOe was 218 emu/cm³.

### Carrier Production Example 3

Carrier particle (c) was obtained in the same manner as in Carrier Producing Example 2 except that oleophilic magnetite B was used as the oleophilic magnetite powder, which is obtained by adding 4.5% by weight of the silane coupling agent (3-(2-aminoethylaminopropyl)dimethoxysilane) to oleophilic magnetite powder and rapidly stirred and mixing at 100° C. in the mixing vessel for providing lyophilicity to the magnetite powder. The specified resin dispersion type Carrier C was obtained by using the carrier particle (c) in the same manner as in Carrier Production Example 1. The specified resin dispersion type Carrier C had a volume based median diameter of 41 μm, a shape coefficient SF-1 of 1.04 and a shape coefficient SF-2 of 1.95. The strength of magnetization at 1 kOe was 220 emu/cm³.

### Carrier Producing Example 4

In a radical polymerizable monomer composition composed of 8 parts by weight of styrene, 2 parts by weight of 2-ethylhexyl acrylate, 1 part by weight of divinylbenzene, 60 parts by weight of the oleophilic magnetite powder A and 40 parts by weight of the oleophilic α-iron oxide were dispersed and 0.3 parts by weight of a radical polymerization initiator (lauroyl peroxide) was added to prepare a carrier forming liquid.

On the other hand, 600 parts by weight of deionized water and 500 parts by weight of a 0.1 moles/L aqueous solution of Na₃PO₄ were charged in a 2 L four-mouth flask having a high speed mixing device TK type Homomixer, manufactured by Tokushu Kika Kogyo Co., Ltd., and a baffle plate, and heated by 65° C., and then 70 parts by weight of a 1.0 mol/L aqueous solution of CaCl₂ was gradually added while stirring at 14,000 rpm to prepare an aqueous medium containing extremely fine particle of sparingly soluble dispersion stabilizer of Ca₃(PO₄)₂. Then the carrier forming liquid was added into the aqueous medium and oil droplets of the carrier forming liquid were formed in the aqueous medium by stirring at 14,000 rpm by the high speed stirring device KT type Homomixer, manufactured by Tokushu Kika Kogyo Co., Ltd. After that, the stirrer was changed to a propeller type stirring wing and the system was heated by 75° C. and subjected to polymerization reaction for 8 hours. Then the system was cooled and hydrochloric acid was added to remove the dispersion stabilizer. Thereafter, the droplets were filtered, washed and dried to obtain the specified dispersion type Carrier D.

The specified resin dispersion type Carrier D in the same manner as in Carrier Production Example 1 using the specific resin dispersion Carrier D as the core particle.

The specified resin dispersion type Carrier D had a volume based median diameter of 44 μm, a shape coefficient SF-1 of 1.05 and a shape coefficient SF-2 of 1.31. The strength of magnetization at 1 kOe was 129 emu/cm³.

### Comparative Carrier Production Example 1

Comparative Carrier E composed of silicone resin coated Li-ferrite particle prepared by a sintering method which had a shape coefficient SF-1 of 1.3 and a shape coefficient SF-2 of 2.52 was prepared. The volume based median diameter of this carrier was 45 μm.

### Comparative Carrier Production Example 2

To 100 parts by weight of polyester resin having a softening point of 150° C., 900 parts by weight of magnetite powder having a number average primary particle diameter of 0.24 μm was added, and melted and kneaded by a biaxial extruder. Then the resultant matter was crushed by a mechanical crushing machine. Thus crushed powder having a volume based median diameter of 38 μm was obtained. The shape of crushed powder was made to sphere by heating at 180° C. for 5 seconds by an instantaneous heat treating apparatus and the resultant particles were coated by the silicone resin in the same manner as in Carrier Production Example 1 to prepare Comparative Carrier F.

The specified resin dispersion type Carrier F had a volume based median diameter of 39 μm, a shape coefficient SF-1 of 1.02 and a shape coefficient SF-2 of 1.04. The strength of magnetization at 1 kOe was 218 emu/cm⁻¹.

### Toner Production Example Bk1

Into a 2 L four-mouth flask provided with the high speed mixing apparatus TK type Homomixer, manufactured by Tokushu Kika Kogyo Co., Ltd., and a baffle plate, 600 parts by weight of deionized water and 500 parts by weight of a 0.1 mols/L Na₃PO₄ aqueous solution were charged and heated by 65° C. and then 70 parts by weight of a 1.0 mol/L aqueous solution of CaCl₂ was gradually added while stirring at 12,000 rpm to prepare an aqueous medium containing extremely fine particle of sparingly soluble dispersion stabilizer of Ca₃(PO₄)₂.

On the other hand, 78 parts by weight of styrene, 22 parts by weight of 2-ethylhexyl acrylate, 7 parts by weight of carbon black, 9 parts by weight of Releasing agent 2 and 1 part by weight of Releasing agent 6 were mixed and dispersion treated for 3 hours by an attritor, manufactured by Mitsui Kinzoku Co., Ltd., and then 8 parts by weight of 2,2′-azobis(2,4-dimethyl-valeronitrile) was added to prepare a toner forming polymerizable monomer composition.

The toner forming polymerizable monomer composition was added to the above aqueous medium and stirred at 12,000 rpm by the high speed stirring machine for 15 minutes under nitrogen atmosphere at an interior temperature of 65° C. to form toner particles. After that the stirring machine was replaced by a propeller wing stirrer, and the above resultant suspension was maintained at the same temperature for 10 hours while controlling the particle shape by the rotating rate of the stirrer wing and the angle of the baffle plate to complete the polymerization treatment. After that, the suspension was cooled and diluted hydrochloric acid was added for removing the dispersion stabilizer, and then the suspended particles were separated and repeatedly washed and dried to obtain Toner Particle (Bk-1).

Toner Particle (Bk-1) had a volume based median diameter of 6.5 μm, a peak molecular weight of 14,000, a molecular weight distribution ((Mw/Mn) of 8 and a softening point of 125° C.

The volume based median diameter was determined according to the particle size distribution within the range of from 2.0 to 40 μm measured by Coulter Multisizer, manufactured by Coulter Co., Ltd., using an aperture of 50 μm. The peak molecular weight and the molecular weight distribution were measured by gel permeation chromatography, and the softening point was measured by a Koka type flow tester.

Black Toner (Bk-1) was obtained by dry state mixing 100 parts by weight of Toner Particle (Bk-1) and silica fine powder having a BET specific area of 140 m²/g and treated by silicone oil using a Henschel mixer.

The shape and particle diameter of Toner Particle (Bk-1) were not varied by the addition of the silica fine particles.

TABLE 1

| | | Ratio of | | |
|---|---|---|---|---|
| | | branch in | Melting | |
| Releasing | | hydrocarbon | point | Molecular |
| agent No. | Substance | compound (%) | (° C.) | weight |
| 1 | Paraffin wax | — | 55 | — |
| 2 | Paraffin wax | — | 67 | — |
| 3 | Polyethylene wax | — | 72 | — |
| 4 | Fischer-Tropsch wax | — | 77 | — |
| 5 | Fischer-Tropsch wax | — | 90 | — |
| 6 | Microcrystalline wax | 0.1 | 75 | 700 |
| 7 | Microcrystalline wax | 0.3 | 80 | 640 |
| 8 | Microcrystalline wax | 0.4 | 80 | 600 |
| 9 | Microcrystalline wax | 1 | 81 | 550 |
| 10 | Microcrystalline wax | 20 | 82 | 510 |
| 11 | Microcrystalline wax | 30 | 82 | 510 |

### Production Example of Toners Y1, M1 and C1

A yellow toner Y1, magenta toner M1 and cyan toner C1 were each produced in the same manner as in the toner producing example Bk-1 except that the carbon black was replaced by C. I. Pigment Yellow 74, C. I. Pigment Red 122 and I. C. Pigment Blue 15:3, respectively.

### Production Example of Toners Bk2 to C10

Toners Bk2 to C-10 were produced in the same manner as in Toner Production Example Bk1 except that the releasing agents listed in Table 1 and the composition was varied as shown in Tables 2 and 3. Carbon black was used as the colorant in Toners Bk2 to Bk10, C. I. Pigment Yellow 74 was used as the colorant in Toners Y2 to Y10, C. I. Pigment Red 122 was used as the colorant in Toners M2 to M10, and C. I. Pigment Blue 15:3 was used as the colorant in Toners C2 to C10.

TABLE 2

| | | Linear-chain | | Branched-chain | | |
|---|---|---|---|---|---|---|
| | | hydrocarbon | | hydrocarbon | | |
| | | compound | | compound | | |
| | | | Adding | | Adding | |
| | | | amount | | amount | |
| | | Releasing | (Parts | Releasing | (Pats | |
| | | agent | by | agent | by | Production |
| Toner | | No. | weight) | No. | weight) | method |
| Inventive | Bk1 | 2 | 9 | 6 | 1 | *1 |
| | Y1 | 2 | 9 | 6 | 1 | *1 |
| | M1 | 2 | 9 | 6 | 1 | *1 |
| | C1 | 2 | 9 | 6 | 1 | *1 |
| | Bk2 | 2 | 9 | 7 | 1 | *1 |
| | Y2 | 2 | 9 | 7 | 1 | *1 |
| | M2 | 2 | 9 | 7 | 1 | *1 |
| | C2 | 2 | 9 | 7 | 1 | *1 |
| | Bk3 | 2 | 9 | 8 | 1 | *1 |
| | Y3 | 2 | 9 | 8 | 1 | *1 |
| | M3 | 2 | 9 | 8 | 1 | *1 |
| | C3 | 2 | 9 | 8 | 1 | *1 |
| | Bk4 | 2 | 9 | 9 | 3 | *1 |
| | Y4 | 2 | 9 | 9 | 3 | *1 |
| | M4 | 2 | 9 | 9 | 3 | *1 |
| | C4 | 2 | 9 | 9 | 3 | *1 |
| | Bk5 | 2 | 8 | 10 | 2 | *1 |
| | Y5 | 2 | 8 | 10 | 2 | *1 |
| | M5 | 2 | 8 | 10 | 2 | *1 |
| | C5 | 2 | 8 | 10 | 2 | *1 |
| | Bk6 | 2 | 7 | 11 | 3 | *1 |
| | Y6 | 2 | 7 | 11 | 3 | *1 |
| | M6 | 2 | 7 | 11 | 3 | *1 |
| | C6 | 2 | 7 | 11 | 3 | *1 |
| | Bk7 | 1 | 8 | 9 | 2 | *1 |
| | Y7 | 1 | 8 | 9 | 2 | *1 |
| | M7 | 1 | 8 | 9 | 2 | *1 |
| | C7 | 1 | 8 | 9 | 2 | *1 |
| | Bk8 | 3 | 8 | 9 | 2 | *1 |
| | Y8 | 3 | 8 | 9 | 2 | *1 |
| | M8 | 3 | 8 | 9 | 2 | *1 |
| | C8 | 3 | 8 | 9 | 2 | *1 |

*1: Suspension polymerization method

TABLE 3

| | | Linear-chain | | Branched-chain | | |
|---|---|---|---|---|---|---|
| | | hydrocarbon | | hydrocarbon | | |
| | | compound | | compound | | |
| | | | Adding | | Adding | |
| | | | amount | | amount | |
| | | Releasing | (Parts | Releasing | (Parts | |
| | | agent | by | agent | by | Production |
| Toner | | No. | weight) | No. | weight) | method |
| Inventive | Bk9 | 4 | 8 | 9 | 2 | *1 |
| | Y9 | 4 | 8 | 9 | 2 | *1 |
| | M9 | 4 | 8 | 9 | 2 | *1 |
| | C9 | 4 | 8 | 9 | 2 | *1 |
| | Bk10 | 5 | 8 | 9 | 2 | *1 |
| | Y10 | 5 | 8 | 9 | 2 | *1 |
| | M10 | 5 | 8 | 9 | 2 | *1 |
| | C10 | 5 | 8 | 9 | 2 | *1 |
| | Bk11 | 1 | 8 | 9 | 4 | *2 |
| | Y11 | 1 | 8 | 9 | 4 | *2 |
| | M11 | 1 | 8 | 9 | 4 | *2 |
| | C11 | 1 | 8 | 9 | 4 | *2 |
| | Bk12 | 3 | 8 | 9 | 4 | *2 |
| | Y12 | 3 | 8 | 9 | 4 | *2 |
| | M12 | 3 | 8 | 9 | 4 | *2 |
| | C12 | 3 | 8 | 9 | 4 | *2 |
| Compar- | Bk13 | 2 | 10 | — | — | *1 |
| ative | Y13 | 2 | 10 | — | — | *1 |
| | M13 | 2 | 10 | — | — | *1 |
| | C13 | 2 | 10 | — | — | *1 |
| | Bk14 | — | — | 9 | 10 | *1 |
| | Y14 | — | — | 9 | 10 | *1 |
| | M14 | — | — | 9 | 10 | *1 |
| | C14 | — | — | 9 | 10 | *1 |
| | Bk15 | 2 | 0.8 | 6 | 9.2 | *1 |
| | Y15 | 2 | 0.8 | 6 | 9.2 | *1 |
| | M15 | 2 | 0.8 | 6 | 9.2 | *1 |
| | C15 | 2 | 0.8 | 6 | 9.2 | *1 |
| | Bk16 | 2 | 9.8 | 6 | 0.2 | *1 |
| | Y16 | 2 | 9.8 | 6 | 0.2 | *1 |
| | M16 | 2 | 9.8 | 6 | 0.2 | *1 |
| | C16 | 2 | 9.8 | 6 | 0.2 | *1 |

*1: Suspension polymerization method
*2: Crushing method

### Toner Production Example Bk11

One hundred parts by weight of styrene-2-ethylhexyl acrylate copolymer having a glass transition temperature (Tg) of 50° C., and a softening point of 123° C., 7 parts by weight of carbon black, and a releasing agent mixture composed of 8 parts by weight of releasing agent 1 and 4 parts by weight of Releasing agent 9, each shown in Table 1, were mixed. The resultant mixture was melted and kneaded in a biaxial extruder and cooled. Thus obtained kneaded matter was roughly crushed by a hammer mill and finely crushed by a jet mill. The finely crushed powder was classified to obtain colored particles Bk1 having a volume based median diameter of 6.9 μm. Black Toner Bk11 was obtained by mixing the colored particle Bk1 with the silica in the same manner as in Toner Production Example 1.

### Production Example of Toners Y11, M11 and C11

A yellow toner Y11, magenta toner M11 and cyan toner C11 were each produced in the same manner as in the toner producing example Bk11 except that the carbon black was replaced by C. I. Pigment Yellow 74, C. I. Pigment Red 122 and I. C. Pigment Blue 15:3, respectively.

### Production Examples of Toners Bk12 to C12

Toners Bk12 to C12 were produced in the same manner as in Toner Production Examples of Toners Bk11 to C11 except that the Releasing agents 3 and 9 listed in Table 1 were used and the composition was varied as show in Table 3.

### Production Examples of Comparative Toners Bk13 to C16>

Comparative Toners Bk13 to C16 were obtained in the same manner as in Toner Production Example Bk1 except that Releasing agents 2, 6 and 9 listed in Table 1 were used and the composition was varied as shown in Table 3. Carbon black was used as the colorant in Toners Bk13 to Bk16, C. I. Pigment Yellow 74 was used as the colorant in Toners Y13 to Y16, C. I. Pigment Red 122 was used as the colorant in Toners M13 to M16, and C. I. Pigment Blue 15:3 was used as the colorant in Toners C13 to C16.

### Production Examples of Double-Component Developers Bk1 to C19

Double-component Developers Bk1 to C12 and comparative double-component Developers Bk13 to C19 were prepared by mixing Toners Bk1 to C12, comparative Toners Bk13 to C16, and Carriers A to D and comparative Carriers E and F were mixed as shown in Table 4 so that the toner concentration was made to 6%.

TABLE 4

| | | |
|---|---|---|
| Developer No. | Carrier No. | Toner No. |

| | | | |
|---|---|---|---|
| Invention | Bk1 | A | Bk1 |
| | Y1 | A | Y1 |
| | M1 | A | M1 |
| | C1 | A | C1 |
| | Bk2 | A | Bk2 |
| | Y2 | A | Y2 |
| | M2 | A | M2 |
| | C2 | A | C2 |
| | Bk3 | A | Bk3 |
| | Y3 | A | Y3 |
| | M3 | A | M3 |
| | C3 | A | C3 |
| | Bk4 | A | Bk4 |
| | Y4 | A | Y4 |
| | M4 | A | M4 |
| | C4 | A | C4 |
| | Bk5 | A | Bk5 |
| | Y5 | A | Y5 |
| | M5 | A | M5 |
| | C5 | A | C5 |
| | Bk6 | B | Bk6 |
| | Y6 | B | Y6 |
| | M6 | B | M6 |
| | C6 | B | C6 |
| | Bk7 | C | Bk7 |
| | Y7 | C | Y7 |
| | M7 | C | M7 |
| | C7 | C | C7 |
| | Bk8 | D | Bk8 |
| | Y8 | D | Y8 |
| | M8 | D | M8 |
| | C8 | D | C8 |
| | Bk9 | A | Bk9 |
| | Y9 | A | Y9 |
| | M9 | A | M9 |
| | C9 | A | C9 |
| | Bk10 | A | Bk10 |
| | Y10 | A | Y10 |
| | M10 | A | M10 |
| | C10 | A | C10 |
| Invention | Bk11 | A | Bk11 |
| | Y11 | A | Y11 |
| | M11 | A | M11 |
| | C11 | A | C11 |
| | Bk12 | A | Bk12 |
| | Y12 | A | Y12 |
| | M12 | A | M12 |
| | C12 | A | C12 |
| Comparative | Bk13 | E(Comparative) | Bk1 |
| | Y13 | E(Comparative) | Y1 |
| | M13 | E(Comparative) | M1 |
| | C13 | E(Comparative) | C1 |
| | Bk14 | F(Comparative) | Bk1 |
| | Y14 | F(Comparative) | Y1 |
| | M14 | F(Comparative) | M1 |
| | C14 | F(Comparative) | C1 |
| | Bk15 | A | Bk13(Comparative) |
| | Y15 | A | Y13(Comparative) |
| | M15 | A | M13(Comparative) |
| | C15 | A | C13(Comparative) |
| | Bk16 | A | Bk14(Comparative) |
| | Y16 | A | Y14(Comparative) |
| | M16 | A | M14(Comparative) |
| | C16 | A | C14(Comparative) |
| | Bk17 | E(Comparative) | Bk13(Comparative) |
| | Y17 | E(Comparative) | Y13(Comparative) |
| | M17 | E(Comparative) | M13(Comparative) |
| | C17 | E(Comparative) | C13(Comparative) |
| | Bk18 | A | Bk15(Comparative) |
| | Y18 | A | Y15(Comparative) |
| | M18 | A | M15(Comparative) |
| | C18 | A | C15(Comparative) |
| | Bk19 | A | Bk16(Comparative) |
| | Y19 | A | Y16(Comparative) |
| | M19 | A | M16(Comparative) |
| | C19 | A | C16(Comparative) |

### Examples 1 to 12 and Comparative Examples 1 to 7

Practical copying test was carried out in which a full color image having a pixel ratio of each color of 5% was printed 50,000 sheets one by one and finally a black solid image was printed under a high temperature and high humidity condition (32° C. and 85% RH) using each of the above obtained double-component Developers Bk1 to C12 and comparative Developers Bk13 to C19 in the combination shown in Table 5 by a digital copying machine Bizhub Pro C350, manufactured by Konica Minolta Co., Ltd, in which the following fixing device was installed. The absolute reflective densities of the first and 50,000th prints were measured by a reflective densitometer RD-918, manufactured by Macbeth Co., Ltd., and the fog was measured as follows. Moreover, the area of the color reproducible range was determined from the L*a*b* color space graph of each of the first and 50,000th printed image measured by a color-difference meter CM-2002, manufactured by Minolta Co., Ltd. The area of color reproducible range of the 50,000′ print was calculated when the area of the first print was set at 100. Moreover, the rubbing resistivity of the finally printed black solid image was evaluated. Results are shown in Table 5.

### <<Fixing Device>>

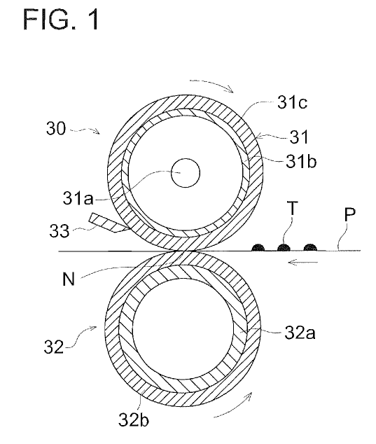

The fixing device was one shown in FIG. 1. The concrete constitution was as follows. The device was constituted by a heating roller 31 and a pressing roller 32. The heating roller 31 was composed of a cylindrical core metal of iron 31b having an internal diameter of 30 mm, thickness of 0.6 mm and a whole width of 310 mm and a covering layer 31c of 50 μm composed of PFA tube. Inside of the heating roller 31, a heater 31a was provided at the central portion thereof. The was composed of a cylindrical ion core metal 32a having an internal diameter of 30 mm and a thickness of 2 mm and a covering layer 32b composed of silicone rubber sponge having an Ascar C hardness of 48° and a thickness of 2 mm covering the core metal. The pressing roller 32 was contacted to the heating roller by applying the total load of 150 N so as to form a fixing nipping portion N of 3.6 mm width. In FIG. 1, T is a toner image formed on the transfer material P and 33 is a separation claw.

The fixing device was used at a fixing temperature of 140° C. and a line speed of printing of 160 mm/sec.

### (Evaluation of Fog Density)

The density of white pare is defined by the average of the absolute image densities measured by the reflective densitometer RD-918, manufactured by Macbeth Co., Ltd., at 20 points on white paper without printed image. The absolute densities were measured at 20 points on white portion of the image to be evaluated and averaged. The difference between thus obtained averaged density and the white paper density was evaluated as the fog density. A fog density of not more than 0.05 did not causes any problem in the practical use.

### (Rubbing Resistivity)

Fixing ratio was determined as to the black solid image printed on the 50,001 st sheet by the following mending tape peeling method.

### (Mending Tape Peeling Method)

The mending tape peeling method was carried out by the following procedure.

1) The absolute reflective density D₀ was measured.

2) Mending tape No. 810-3-12 was lightly pasted on the black solid image.

2) The surface of the mending tape was rubbed go and return for 3.5 times with a pressure of 1 kPa.

4) The mending tape was peeled off by a force of 200 g at an angle of 180°.

5) The absolute density of D₁ of the image after peeling of the mending tape.

6) The fixing ratio was calculated according to the following Formula (ii).

Formula (ii)

Fixing ratio(%)=D₁/D₀×100

The absolute density was measured by the reflective densitometer RD-918 manufactured by Macbeth Co., Ltd.

TABLE 5

| | Combination of | Color reproducible range | | | | | |
|---|---|---|---|---|---|---|---|
| | double- | Image density | | Fog density | | Color | Rubbing |
| | component | | 50,000^{th} | | 50,000^{th} | reproducible | resistivity |
| | developers | initial | sheet | initial | sheet | range(%) | (%) |
| Example 1 | Bk1/Y1/M1/C1 | 1.42 | 1.41 | 0 | 0.001 | 98 | 99 |
| Example 2 | Bk2/Y2/M2/C2 | 1.42 | 1.41 | 0 | 0.001 | 98 | 98 |
| Example 3 | Bk3/Y3/M3/C3 | 1.42 | 1.41 | 0.001 | 0.001 | 98 | 99 |
| Example 4 | Bk4/Y4/M4/C4 | 1.42 | 1.41 | 0 | 0.001 | 98 | 97 |
| Example 5 | Bk5/Y5/M5/C5 | 1.42 | 1.4 | 0 | 0.001 | 98 | 95 |
| Example 6 | Bk6/Y6/M6/C6 | 1.42 | 1.41 | 0 | 0.001 | 98 | 95 |
| Example 7 | Bk7/Y7/M7/C7 | 1.42 | 1.41 | 0 | 0.001 | 97 | 95 |
| Example 8 | Bk8/Y8/M8/C8 | 1.42 | 1.4 | 0 | 0.001 | 97 | 94 |
| Example 9 | Bk9/Y9/M9/C9 | 1.42 | 1.40 | 0.001 | 0.001 | 96 | 97 |
| Example 10 | Bk10/Y10/M10/C10 | 1.42 | 1.40 | 0 | 0.001 | 96 | 97 |
| Example 11 | Bk11/Y11/M11/C11 | 1.42 | 1.39 | 0.001 | 0.003 | 95 | 96 |
| Example 12 | Bk12/Y12/M12/C12 | 1.42 | 1.39 | 0.001 | 0.003 | 94 | 96 |
| Comparative | Bk13/Y13/M13/C13 | 1.42 | 1.36 | 0.001 | 0.008 | 87 | 99 |
| example 1 | | | | | | | |
| Comparative | Bk14/Y14/M14/C14 | 1.42 | 1.33 | 0 | 0.009 | 98 | 99 |
| example 2 | | | | | | | |
| Comparative | Bk15/Y15/M15/C15 | 1.42 | 1.29 | 0.001 | 0.008 | 79 | 99 |
| example 3 | | | | | | | |
| Comparative | Bk16/Y16/M16/C16 | 1.42 | 1.38 | 0 | 0.002 | 98 | 79 |
| example 4 | | | | | | | |
| Comparative | Bk17/Y17/M17/C17 | 1.42 | 1.33 | 0.001 | 0.007 | 86 | 99 |
| example 5 | | | | | | | |
| Comparative | Bk18/Y18/M18/C18 | 1.42 | 1.37 | 0.001 | 0.009 | 85 | 75 |
| example 6 | | | | | | | |
| Comparative | Bk19/Y19/M19/C19 | 1.42 | 1.38 | 0.001 | 0.005 | 87 | 92 |
| example 7 | | | | | | | |

As was cleared by the results listed in Table 5, it was confirmed that sufficient image density can be obtained after 50,000 times of image formation, variation in the fog density and in the color reproducible range were small and sufficient rubbing resistivity can be obtained for long period in Examples 1 to 12 relating to the double-component developer of the invention.

1. An electrophotographic developer comprising a toner containing a toner binder resin, a colorant and a releasing agent; and a carrier containing magnetic particles dispersed in a carrier binder resin,
wherein the releasing agent contains a first releasing agent component of a linear-chain hydrocarbon compound having a melting point of from 50 to 100° C., and a second releasing agent component comprising a branched-chain structure hydrocarbon compound having a melting point of from 50 to 100° C., a ratio of the first releasing agent component being from 10 to 95% and a ratio of the second releasing agent component being 5 to 90% by weight based on the total weight of the first and the second releasing agent components, and
the carrier has a shape coefficient SF-1 of from 1.0 to 1.2, a shape-coefficient SF-2 of from 1.1 to 2.5 and a volume based median diameter of from 10 to 100 μm.

2. The electrophotographic developer of claim 1, wherein the linear-chain hydrocarbon compound has a weight average molecular weight of from 300 to 600 and a number average molecular weight of from 300 to 500.

3. The electrophotographic developer of claim 2, wherein the number average molecular weight of from 400 to 500.

4. The electrophotographic developer of claim 1, wherein the linear-chain hydrocarbon compound has a ratio of the weight average molecular weight to the number average molecular weight Mw/Mn of from 1.0 to 1.20.

5. The electrophotographic developer of claim 1, wherein the first releasing agent component is paraffin wax, a Fischer-Tropsch wax and polyethylene wax.

6. The electrophotographic developer of claim 1, wherein branched-chain structure hydrocarbon compound has a ratio of branch of from 0.1 to 20%.

7. The electrophotographic developer of claim 1, wherein branched-chain structure hydrocarbon compound has a ratio of branch of from 0.3 to 1.0%.

8. The electrophotographic developer of claim 7, wherein microcrystalline wax has a carbon number of from 30 to 50, a weight average molecular weight of from 500 to 800 and a melting point of from 60 to 90° C.

9. The electrophotographic developer of claim 8, wherein microcrystalline wax has a weight average molecular weight of from 600 to 800 and a melting point of from 60 to 85° C.

10. The electrophotographic developer of claim 7, wherein microcrystalline wax has a number average of from 300 to 800.

11. The electrophotographic developer of claim 7, wherein microcrystalline wax has ratio of the weight average molecular weight to the number average molecular weight Mw/Mn of from 1.01 to 1.20.

12. The electrophotographic developer of claim 1, wherein total amount of the first and the second releasing agent components is from 1 to 30% by weight based on the binder resin.

13. The electrophotographic developer of claim 12, wherein total amount of the first and the second releasing agent components is from 5 to 20%, by weight based on the binder resin.

14. The electrophotographic developer of claim 1, wherein magnetic particles are magnetite, γ-iron oxide, Mn—Zn ferrite, Ni—Zn ferrite, Ca—Mg ferrite, Li ferrite or Cu—Zn ferrite.

15. The electrophotographic developer of claim 1, wherein content of the magnetic particles is from 40 to 99% by weight based on the carrier.

16. The electrophotographic developer of claim 15, wherein content of the magnetic particles is from 50 to 70% by weight based on the carrier.

17. The electrophotographic developer of claim 1, wherein the carrier binder resin is a styrene-acryl resin, a polyester resin, a fluororesin, a phenol-formaldehyde resin, an epoxy resin, a urea resin, or a melamine resin.

18. The electrophotographic developer of claim 16, wherein the carrier binder resin is a phenol-formaldehyde resin.

19. The electrophotographic developer of claim 1, wherein the carrier is composed of a core containing magnetic particles dispersed in the carrier binder and a covering resin coated the core.

20. The electrophotographic developer of claim 19, wherein an amount of the covering resin is from 0.1 to 10% by weight of the core.

21. The electrophotographic developer of claim 20, wherein an amount of the covering resin is from 0.3 to 5% by weight of the core.

22. The electrophotographic developer of claim 1, wherein the carrier has a volume based median diameter of from 15 to 80 μm.

23. The electrophotographic developer of claim 1, wherein the carrier has magnetization strength of from 20 to 300 emu/cm³ in a magnetic field of 1 kOe.

24. The electrophotographic developer of claim 1, wherein the second releasing agent component is microcrystalline wax or wax principally composed of isoparaffin.
